(19) United States
(12) Patent Application Publication
(10) Pub. No.: US 2026/0088438 A1
(43) Pub. Date: Mar. 26, 2026

(54) VENT DEFLECTOR ASSEMBLY FOR A BATTERY CELL AND METHOD OF MANUFACTURING THE SAME

(71) Applicant: GM Global Technology Operations LLC, Detroit, MI (US)

(72) Inventors: Tejas R. Bhavsar, Troy, MI (US); Mahesh A. Mummigatti, Bangalore (IN); Hariprasad Srinivasaiah, Bangalore (IN); Ryan Patrick Hickey, Austin, TX (US)

(73) Assignee: GM Global Technology Operations LLC, Detroit, MI (US)

(21) Appl. No.: 18/895,938

(22) Filed: Sep. 25, 2024

(51) Int. Cl. H01M 50/317; H01M 50/15; H01M 50/159; H01M 50/164

(52) U.S. Cl. CPC H01M 50/317; H01M 50/15; H01M 50/159; H01M 50/164; H01M 2200/101; H01M 2220/20

(57) ABSTRACT

A vent deflector assembly for a prismatic battery cell includes a base defining an opening, a hinge having a first portion and a second portion movable with respect to the first portion, the first portion being coupled to the base, and a lid coupled to the second portion of the hinge, the lid being movable between a first position and a second position.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a battery cell and, more particularly, to a thermal runaway propagation management system of a battery cell.

In general, electric vehicles can be equipped with a battery pack that includes one or more battery cells. Lithium-ion batteries are typically used in vehicles due to their high energy and power densities. Sometimes, however, a chain of uncontrolled exothermic reactions can occur within the lithium-ion batteries (i.e., thermal runaway). These reactions can result in a rise in internal temperature of the battery that causes inner structures of the battery to destabilize and degrade and eventually lead to failure of the battery. Some batteries or battery packs include thermal runaway propagation management (TRP) systems, but they either take up a large amount of space or are ineffective during a thermal runaway scenario. Shortcomings of existing systems and methods are addressed by one or more aspects of the present disclosure.

### SUMMARY

In one configuration, a vent deflector assembly for a prismatic battery cell is provided and includes a base defining an opening, a hinge having a first portion and a second portion movable with respect to the first portion, the first portion being coupled to the base, and a lid coupled to the second portion of the hinge, the lid being movable between a first position and a second position.

The vent deflector assembly may include one or more of the following optional aspects. For example, the lid includes a bimetal sandwich structure that includes a first lid and a second lid coupled to the first lid. The first lid can be made of a first material and the second lid can be made of a second material. The first material can be a copper alloy and the second material can be stainless steel.

According to at least one aspect, the opening includes a first edge coupled to the first portion of the hinge and a second edge opposite the first edge. A portion of the lid can be arranged adjacent to the base in the first position and a gap is arranged between the lid and the base. The gap can be between 3.5 mm and 3.8 mm when the lid is in the first position and between 13 mm and 14 mm when the lid is in the second position.

According to another aspect, the lid includes a first dimension and a second dimension, the first dimension being larger than the second dimension. The lid can be configured to open with respect to the first dimension. The lid can be configured to open with respect to the second dimension.

In another configuration, a prismatic battery cell is provided and includes a prismatic can. The prismatic can includes an upper surface, a lower surface, one or more walls extending between the upper surface and the lower surface, and a vent opening arranged in the prismatic can. Battery internals are arranged in the prismatic can and one or more terminals are coupled to the upper surface. The prismatic battery cell further includes a vent deflector assembly arranged with respect to the vent opening and coupled to the prismatic can. The vent deflector assembly includes a base, a hinge coupled to the base, and a lid coupled to hinge and configured to move between a first position and a second position.

The prismatic battery cell may include one or more of the following optional aspects. For example, the opening can include an elongate shape.

According to at least one aspect, the base includes a first end and a second end. The hinge can be coupled to the base between the first end and the second end. The lid can include a bimetal sandwich structure having a first lid made of a first material and a second lid coupled to the first lid and made of a second material, the first material being different than the second material.

In another configuration, a vehicle is provided and includes a vehicle body including a first end, a second end spaced from the first end, a first side, and a second side spaced from the first side, a motor coupled to the vehicle body, and a battery pack coupled to the vehicle body and communicatively coupled to the motor. The battery pack includes one or more modules and one or more battery cells arranged in the one or more modules. The one or more battery cells each includes a prismatic can having a first end, a second end, and one or more side walls and one or more end walls that extend between the first end and the second end, and a vent deflector assembly including a base coupled to the prismatic can, a hinge coupled to the base, and a lid coupled to the hinge.

The vehicle may include one or more of the following optional aspects. For example, the vent deflector assembly may be coupled to the second end of the prismatic can. The vent deflector assembly can be configured to deflect high temperature gasses toward one of the first side or the second side of the vehicle body. The vent deflector assembly can be configured to deflect high temperature gasses toward one of the first end or the second end of the vehicle body.

According to at least one aspect, the lid can include a first dimension and a second dimension, the first dimension being larger than the second dimension, the lid being configured to open with respect to one of the first dimension or the second dimension.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle according to principles of the present disclosure;

FIG. 2 is a partial exploded view of a battery pack according to the principles of the present disclosure;

FIG. 3A is a perspective view of a battery cell of the battery pack of FIG. 2 having a first configuration of a vent deflector assembly;

FIG. 3B is an exploded view of the vent deflector assembly of FIG. 3A;

FIG. 3C is a side view of the vent deflector assembly of FIG. 3A in a first position;

FIG. 3D is a perspective view of the vent deflector assembly of FIG. 3A in a second position;

FIG. 4A is a perspective view of a battery cell of the battery pack of FIG. 2 having a second configuration of a vent deflector assembly;

FIG. 4B is a perspective view of the vent deflector assembly of FIG. 4A in a first position;

FIG. 4C is a perspective view of the vent deflector assembly of FIG. 4A in a second position;

FIG. 5A is a perspective view of a battery cell of the battery pack of FIG. 2 having a third configuration of a vent deflector assembly;

FIG. 5B is a perspective view of the vent deflector assembly of FIG. 5A in a first position;

FIG. 5C is a perspective view of the vent deflector assembly of FIG. 5A in a second position;

FIG. 6 is a bottom perspective view of a battery cell of the battery pack of FIG. 2 having a fourth configuration of a vent deflector arranged on a bottom portion of the battery cell; and

FIG. 7 is a flow diagram of a method of manufacturing a battery pack according to the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

In the event of a thermal runaway scenario, more than one battery cell and sometimes, more than one battery module, are affected. Absent a thermal runaway propagation (TRP) management system, system failure and/or costly damage to a vehicle is possible. Battery cells commonly include vents that open toward a passenger compartment (i.e., an interior cabin) of the vehicle. These vents can direct high temperature gasses and battery internals toward a portion of the passenger compartment during a thermal runaway event which can result in devasting damage to the vehicle and to neighboring battery cells. Accordingly, these shortcomings, among others, are addressed by principles of the present disclosure.

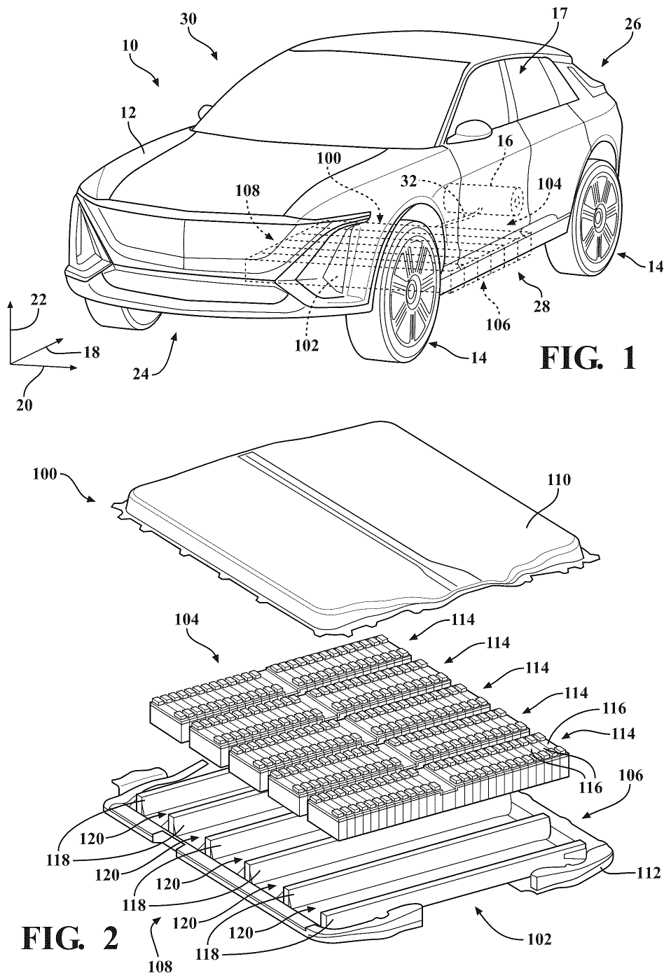

With reference to FIG. 1, a vehicle 10, such as an electric motor vehicle, is provided. The vehicle 10, includes a vehicle body 12, one or more wheels 14 coupled to the vehicle body 12, and an electric motor 16 arranged in and/or coupled to the vehicle body 12. The vehicle body 12 defines a passenger compartment 17 and extends along a first or longitudinal axis (i.e., fore-aft direction) 18, a second or lateral axis (i.e., cross-car direction) 20, and a third or vertical axis 22. The vehicle body 12 can include a first or front end 24, a second or rear end 26 spaced from the front end 24 with respect to the longitudinal axis 18, a first or left side 28, and a second or right side spaced from the left side 30 with respect to the lateral axis 20. The electric motor 16 can be configured to drive one or more of the one or more wheels 14 to propel the vehicle 10. The vehicle 10 includes a battery pack 100 that can be arranged in and/or coupled to the vehicle body 12 and is communicatively coupled to the electric motor 16 via an electric power cable 32.

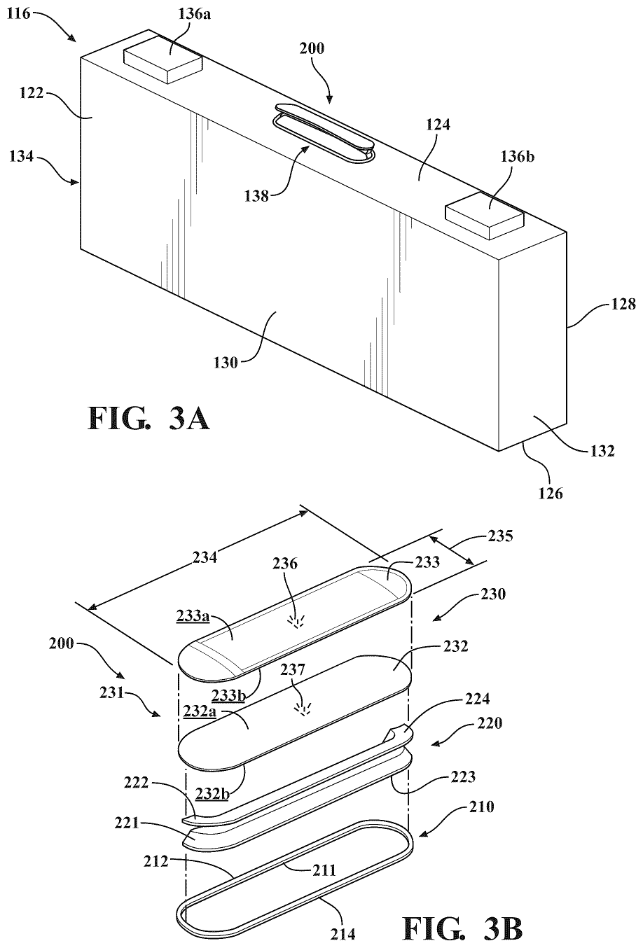

With reference to FIGS. 1 and 2, the battery pack 100 extends at least along the longitudinal axis 18 and the lateral axis 20. The battery pack 100 can have a first or front end 102, a second or rear end 104 spaced from the front end 102 with respect to the longitudinal axis 18, a first or left side 106, and a second or right side 108 spaced from the left side 106 with respect to the lateral axis 20. The battery pack 100 can include a first or upper half 110 and a second or lower half 112 coupled to the upper half 110, as shown in FIG. 2. The upper half 110 and the lower half 112 can be configured to receive one or more battery modules 114 that each have one or more battery cells 116. Additionally, the upper half 110 and the lower half 112 can be configured to protect the one or more battery modules and the one or more battery cells from water, salt, and other elements that the vehicle 10 can encounter during travel, for example. The lower half 112 can include one or more dividers 118 that extend between the right side 108 and the left side 106 with respect to the lateral axis 20. The one or more dividers 118 define receptacles 120 that are configured to receive and retain the one or more battery modules 114. In some configurations, the dividers 118 can separate modules to prevent a thermal runaway event from propagating through the entire battery pack 100, for example.

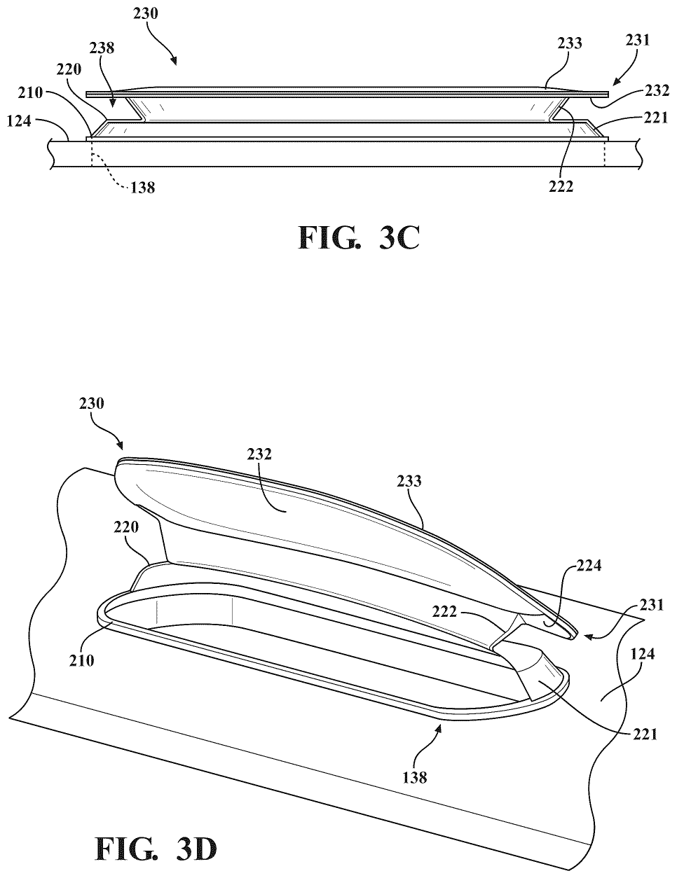

With reference to FIG. 3, an illustrative example of one of the one or more battery cells 116 is provided. In the present illustrative example, the one or more battery cells 116 are prismatic battery cells, however, the principles of the present disclosure can equally apply to other types of battery cells, such as cylindrical battery cells. The one or more battery cells 116 can each include a prismatic can 122 that extends between a first or upper end 124 and a second or lower end 126. The prismatic can 122 includes one or more side walls, such as a first or left side wall 128 and a second or right-side wall 130 spaced from the first side wall 128. Additionally, the prismatic can 122 includes a first or front-end wall 132 and a second or rear end wall 134. In the present example, the first and second side walls 128, 130 have a length that is longer than that of the first and second end walls 132, 134. The prismatic can 122 is configured to house battery internals, such as one or more jelly rolls (not shown). The one or more battery cells 116 include terminals coupled to the upper end 124 and in communication with the battery internals. The terminals can include a positive terminal 136a and a negative terminal 136b, for example. In the present illustrative example, the prismatic can 122 includes a vent opening 138 that extends through the upper end 124 and is arranged axially between the positive terminal 136a and the negative terminal 136b. The one or more battery cells 116 can further include a vent deflector assembly 200 that is arranged in the vent opening 138.

The one or more battery cells 116 can include a mechanical fuse or another mechanism (not shown) that is configured to allow gasses to release from the prismatic can 122 during a thermal runaway event, for example. Heretofore, vents typically guided high temperature gasses and battery internals toward the upper half 110 of the battery pack and/or the passenger compartment 17 of the vehicle 10. With reference to FIGS. 3A and 3B, the vent deflector assembly 200 can be configured to deflect gasses and battery internals laterally toward the left and/or right sides 106, 108 (FIG. 1) of the battery pack 100 or the left and/or right sides 28, 30 (FIG. 1) of the vehicle 10. Controlling the flow of high temperature gasses can be desirable to prevent a thermal runaway event from propagating throughout the battery pack 100, for example.

With reference to FIG. 3B, the vent deflector assembly 200 includes a base 210, a hinge 220, and a lid 230. The base 210 defines an opening 211 that can be the same or a similar shape as the vent opening 138 of the prismatic can 122. According to one aspect, the opening 211 can be an elongate shape, however, other shapes are possible such as circular or rectangular. The base 210 can include a first or front edge 212 and a second or rear edge 214 spaced from the front edge 212. According to another aspect, the base 210 can be made of steel, stainless steel, or another material commonly used for constructing automotive battery cells, for example.

The hinge 220 includes a first or lower half 221 and a second or upper half 222 hingedly coupled to the first half 221. The first half 221 can have a first flange or lip 223 that extends radially and is configured to be coupled to the rear edge 214 of the of the base 210. The second half 222 can have a second flange or lip 224 that extends radially and is configured to be coupled to a portion of the lid 230. According to one aspect, the hinge 220 is configured to move between a first or closed position (FIG. 3C) and a second or open position (FIG. 3D). According to another aspect, the hinge 220 can be made of steel, stainless steel, or another material commonly used for constructing automotive battery cells, for example.

The lid 230 can be configured to selectively deflect high temperature gasses and battery internals away from one of the one or more battery cells 116. With reference to FIG. 3B, the lid 230 can include a bimetal sandwich structure 231 that includes a first or lower lid 232 and a second or upper lid 233. The first lid 232 includes a first or upper surface 232a and a second or lower surface 232b opposite the upper surface 232a. Similarly, the second lid 233 includes a first or upper surface 233a and a second or lower surface 233b opposite the upper surface 233a. The first lid 232 can be configured so that a majority of the upper surface 232a contacts the lower surface 233b of the second lid 233. According to one aspect, the first lid 232 and the second lid 233 can have the same shape or a different shape. In the present illustrative example, the first lid 232 and the second lid 233 are the same shape and correspond with the shape of the opening 211 of the base 210. The lid 230 includes a first or length dimension 234 and a second or width dimension 235. Here, the length dimension 234 is longer than the width dimension 235. According to another aspect, the first lid 232 can be made of a first material 236 and the second lid 233 can be made of a second material 237. In other words, the lid 230 can be a bimetal lid. For instance, the first lid 232 may be made of a copper alloy (e.g., cupronickel) and the second lid 233 may be made of steel or stainless steel. Depending on what materials are selected for the first lid 232 and the second lid 233, one or more joining methods may be used to couple the first lid 232 to the second lid 233. For instance, an adhesive, heat welding, laser welding, spot welding, TIG welding, or another welding technique commonly used in manufacturing automotive battery cells may be used to couple or otherwise attach the first lid 232 to the second lid 233. A portion of the first lid 232 and/or the second lid 233 can be coupled to the upper half 222 and, more particularly, to the second flange 224 of the hinge 220.

During normal operation, the lid 230 can remain in a first position (FIG. 3C). In the first position, the lid 230 can be arranged so that a gap 238 exists between the lid 230 and the base 210. For instance, the gap 238 can range from 3.5 mm to 3.8 mm. When the battery cell 116 undergoes a thermal runaway event, high temperature gasses release from the prismatic can 122 and begin to escape through the gap 238. The high temperature gasses can increase the temperature of the bimetal sandwich structure 231 causing the lid 230 to open to a second position (FIG. 3D) due to the material of the metal changing shape in response to the applied heat. In the present illustrative configuration, the lid 230 is configured to open with respect to the length dimension 234. In operation, the open position (FIG. 3D) of the lid 230 deflects high temperature gasses toward the left or right side 106, 108 of the battery pack 100 and the left or right side 28, 30 of the vehicle 10.

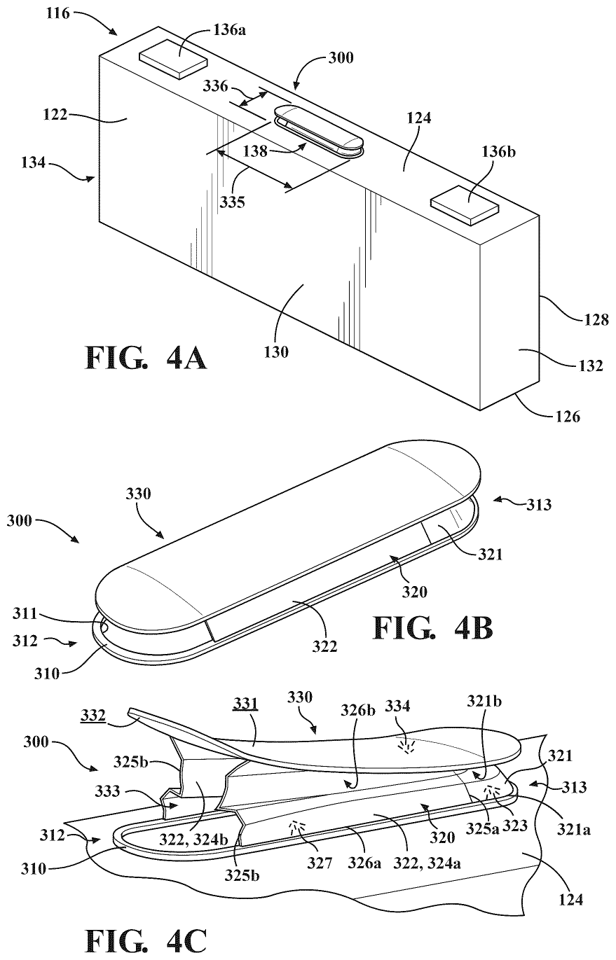

FIGS. 4A, 4B, and 4C illustrate another illustrative configuration of a vent deflector assembly 300. This configuration is similar in many respects to the configuration of FIGS. 1, 2, 3A, 3B, 3C, and 3D. Accordingly, the descriptions of the configurations are hereby incorporated into one another, and description of subject matter common to the configurations generally may not be repeated.

With reference to FIGS. 4A and 4B, the vent deflector assembly 300 can be configured to deflect gasses and battery internals toward the front or rear ends 102, 104 of the battery pack 100 or the front and/or rear ends 24, 26 of the vehicle 10. In other words, the vent deflector 300 can be configured to direct a flow of high temperature gasses toward the positive terminal 136a or the negative terminal 136b. Controlling the flow of high temperature gasses can be desirable to prevent a thermal runaway event of one cell from propagating throughout the battery pack 100, for example.

With reference to FIG. 4B, the vent deflector assembly 300 includes a base 310, a hinge 320, and a lid 330. The base 310 defines an opening 311 that can be the same or a similar shape as the vent opening 138 of the prismatic can 122. According to one aspect, the opening 311 can be an elongate shape, however, other shapes are possible such as circular or rectangular. The base 310 can include a first end 312 and a second end 313 spaced from the first end 312.

With reference to FIG. 4C, the hinge 320 includes a first portion 321 and a second portion 322 coupled to the first portion 321. The first portion 321 is coupled to the second end 313 and can span or extend along an annular portion of the base 310. Additionally, the first portion includes a first or bottom edge 321a and a second or top edge 321b spaced from the bottom edge 321a. In the present illustrative example, the bottom edge 321a contacts and can be coupled to the base 310 via one or more coupling or welding techniques. According to one aspect, the first portion 321 can be made of a first material 323 such as stainless steel. The second portion 322 can include one or more foldable sheets 324a, 324b that are coupled to the first portion 321 and the base 310 and each extend between the first end 312 and the second end 313. In the present illustrative example, the foldable sheets 324a, 324b include a first or rear edge 325a and a second or front edge 325b spaced from the rear edge 325a. The rear edge 325a can be coupled to the first portion 321 via one or more coupling or welding techniques. Additionally, the foldable sheets 324a, 324b include a first or bottom edge 326a and a second or top edge 326b spaced from the bottom edge 326a. The bottom edge 326a can be coupled to the base 310 via one or more coupling or welding techniques. According to one aspect, the second portion can be made of a second material 327 such as a copper alloy (e.g., copper-nickel alloy). In assembly, the first portion 321 and the second portion can be configured to be movable between a first or folded position (FIG. 4B) to a second or extended position (FIG. 4C). According to another aspect, when the first material 323 and the second material 327 are different materials, the hinge 320 can also be referred to as a bi-metal hinge, for example.

The lid 330 can be configured to selectively deflect high temperature gasses and battery internals away from one of the one or more battery cells 116. With reference to FIG. 4C, the lid 330 can be coupled to the hinge 320 and, more particularly, to the first portion 321 and the second portion 322 of the hinge 320. The lid 330 includes a first or upper surface 331 and a second or lower surface 332 opposite the upper surface 331. The bottom surface 332 can be coupled to the top edge 321b of the first portion and the top edge 326b of the foldable sheets 324a, 324b. According to one aspect, the deflector assembly can include a passage 333 arranged between the bottom surface 332 of the lid 330, the front edges 325a, 325b of the foldable sheets 324a, 324b, and the first end 312 of the base 310. According to another aspect, the lid 330 can be made of the first material 323, the second material 327, or a third material 334 that is different than the first material 323 and the second material 327. According to yet another aspect, the lid 330 includes a first or length dimension 335 and a second or width dimension 336, as shown in FIG. 4A. Here, the length dimension 335 is longer than the width dimension 336.

During normal operation, the lid 330 can remain in a first position (FIG. 4B). When the battery cell 116 undergoes a thermal runaway event, high temperature gasses release from the prismatic can 122 and increase the temperature of the foldable sheets 324a, 324b causing the lid 330 to open to a second position (FIG. 4C). In the present illustrative configuration, the lid 330 is configured to open with respect to the second or width dimension 336. Depending on the orientation of the battery cell 116, the lid 330 can deflect high temperature gasses toward the front or rear ends 102, 104 of the battery pack 100 or the front and/or rear ends 24, 26 of the vehicle 10.

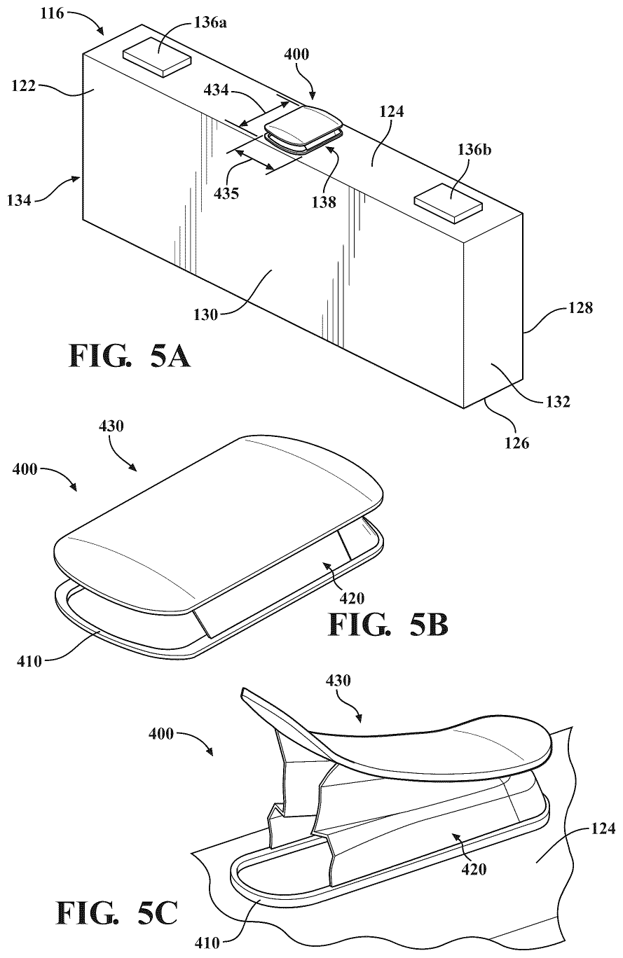

FIGS. 5A, 5B, and 5C illustrate another illustrative configuration of a vent deflector assembly 400. This configuration is similar in many respects to the configuration of FIGS. 1, 2, 3A-3D and FIGS. 4A-4C. Accordingly, the descriptions of the configurations are hereby incorporated into one another, and description of subject matter common to the configurations generally may not be repeated.

With reference to FIGS. 5A and 5B, the vent deflector assembly 400 can be configured to deflect gasses and battery internals laterally toward the left and/or right sides 106, 108 of the battery pack 100 or the left and/or right sides 28, 30 of the vehicle 10. Controlling the flow of high temperature gasses can be desirable to prevent a thermal runaway event of one cell from propagating throughout the battery pack 100, for example.

With reference to FIG. 5B, the vent deflector assembly 400 includes a base 410, a hinge 420, and a lid 430. The vent deflector assembly 400 is arranged between the positive terminal 136a and the negative terminal 136b, as shown in FIG. 5A. The lid 430 includes a first or length dimension 434 and a second or width dimension 435. Here, the length dimension 434 is longer than the width dimension 435.

During normal operation, the lid 430 can remain in a first position (FIG. 5B). When the battery cell 116 undergoes a thermal runaway event, high temperature gasses release from the prismatic can 122 and increase the temperature of the lid 430 causing the lid 430 to open to a second position (FIG. 5C). In the present illustrative configuration, the lid 430 is configured to open with respect to the second or width dimension 435. Depending on the orientation of the battery cell 116, the lid 430 can deflect high temperature gasses toward the left or right side 106, 108 of the battery pack 100 and the left or right side 28, 30 of the vehicle 10.

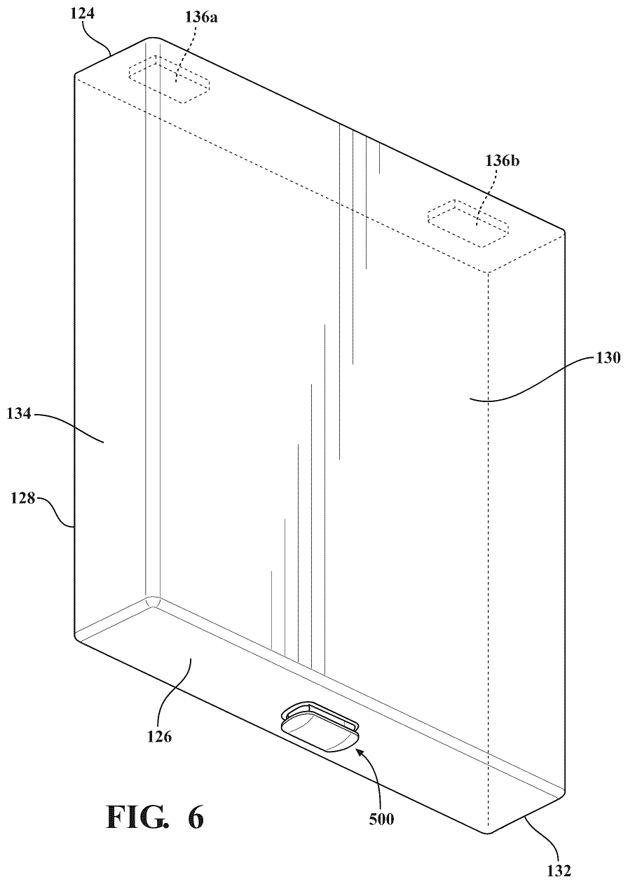

FIG. 6 illustrates another illustrative configuration of a vent deflector assembly 500. This configuration is similar in many respects to the configuration of FIGS. 1, 2, 3A-3D, FIGS. 4A-4C, and FIGS. 5A-5C. Accordingly, the descriptions of the configurations are hereby incorporated into one another, and description of subject matter common to the configurations generally may not be repeated.

With reference to FIG. 6, the vent deflector assembly 500 is arranged on the lower end 126 of the prismatic can 122. Any of the vent deflectors introduced above may be selected to be coupled to lower end of the prismatic can. Arranging the vent deflector assembly 500 on the lower end 126 may be desirable to deflect high temperature gases toward the lower half 112 of the battery pack 100 or toward a surface (i.e., the road) below the vehicle 10, for example.

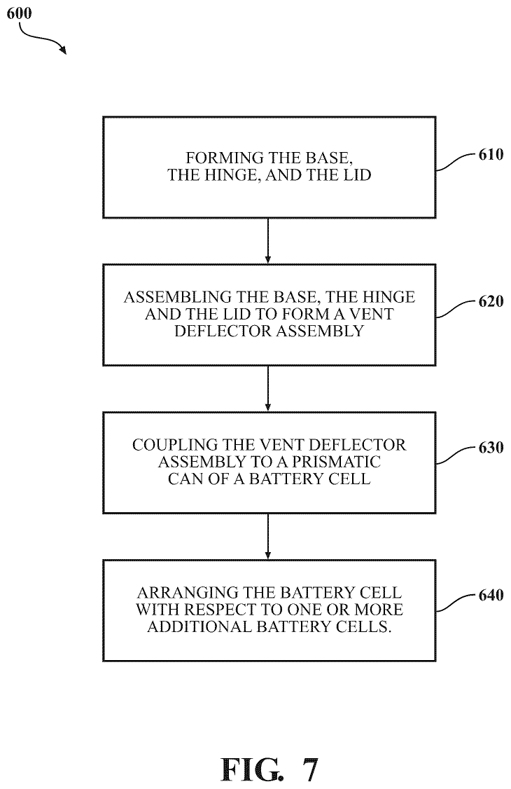

With reference to FIG. 7, a method 600 of manufacturing a battery pack including one or more battery cells that each have a vent deflector assembly is provided. The method 600 will be introduced with respect to the battery pack 100 and vent deflector assembly 200 introduced above. However, the principles equally apply to manufacturing battery packs with different configurations of the vent deflector assemblies 300, 400, 500 as well.

At 610, the base 210, the hinge 220, and the lid 230 are blanked and/or stamped from copper, steel, or another material commonly used to manufacture automotive battery cells.

At 620, the vent deflector assembly (i.e., the base 210, the hinge 220, and the lid 230) is assembled using one or more coupling or welding techniques. For instance, as mentioned above, an adhesive, heat welding, laser welding, spot welding, TIG welding, or another welding technique commonly used in manufacturing automotive battery cells may be used to couple or otherwise attach the base 210, the hinge 220, and the lid 230 (i.e., the first lid 232 and the second lid 233). In other words, the components may be coupled or otherwise attached with a durable and reliable connection that can withstand mechanical stress and environmental conditions.

At 630, the vent deflector assembly 200 is arranged with respect to the vent opening 138 of the prismatic can 122. A laser or another coupling technique can then be used to couple or otherwise attach the vent deflector assembly 200 to the prismatic can 122.

At 640, the battery cell 116 can be arranged with respect one or more additional battery cells 116 within the one or more modules 114 or within the receptacles 120 of the battery pack 100.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vent deflector assembly for a prismatic battery cell, comprising:
a base defining an opening;
a hinge having a first portion and a second portion movable with respect to the first portion, the first portion being coupled to the base; and
a lid coupled to the second portion of the hinge, the lid being movable between a first position and a second position.

2. The vent deflector assembly of claim 1, wherein the lid includes a bimetal sandwich structure that includes a first lid and a second lid coupled to the first lid.

3. The vent deflector assembly of claim 2, wherein the first lid is made of a first material and the second lid is made of a second material.

4. The vent deflector assembly of claim 3, wherein the first material is a copper alloy and the second material is stainless steel.

5. The vent deflector assembly of claim 1, wherein the opening includes a first edge coupled to the first portion of the hinge and a second edge opposite the first edge.

6. The vent deflector assembly of claim 5, wherein a portion of the lid is arranged adjacent to the base in the first position and a gap is arranged between the lid and the base.

7. The vent deflector assembly of claim 6, wherein the gap is between 3.5 mm and 3.8 mm when the lid is in the first position and between 13 mm and 14 mm when the lid is in the second position.

8. The vent deflector assembly of claim 1, wherein the lid includes a first dimension and a second dimension, the first dimension being larger than the second dimension.

9. The vent deflector assembly of claim 8, wherein the lid is configured to open with respect to the first dimension.

10. The vent deflector assembly of claim 8, wherein the lid is configured to open with respect to the second dimension.

11. A prismatic battery cell, comprising:
a prismatic can, comprising:
an upper surface,
a lower surface,
one or more walls extending between the upper surface and the lower surface, and
a vent opening arranged in the prismatic can;
battery internals arranged in the prismatic can;
one or more terminals coupled to the upper surface; and
a vent deflector assembly arranged with respect to the vent opening and coupled to the prismatic can, comprising:
a base,
a hinge coupled to the base, and
a lid coupled to hinge and configured to move between a first position and a second position.

12. The prismatic battery cell of claim 11, wherein the opening includes an elongate shape.

13. The prismatic battery cell of claim 11, wherein the base includes a first end and a second end.

14. The prismatic battery cell of claim 13, wherein the hinge is coupled to the base between the first end and the second end.

15. The prismatic battery cell of claim 14, wherein the lid includes a bimetal sandwich structure having a first lid made of a first material and a second lid coupled to the first lid and made of a second material, the first material being different than the second material.

16. A vehicle, comprising:
a vehicle body including a first end, a second end spaced from the first end, a first side, and a second side spaced from the first side;
a motor coupled to the vehicle body; and
a battery pack coupled to the vehicle body and communicatively coupled to the motor, the battery pack comprising:
one or more modules; and
one or more battery cells arranged in the one or more modules, the one or more battery cells comprising:
a prismatic can having a first end, a second end, and one or more side walls and one or more end walls that extend between the first end and the second end, and
a vent deflector assembly including a base coupled to the prismatic can, a hinge coupled to the base, and a lid coupled to the hinge.

17. The vehicle of claim 16, wherein the vent deflector assembly is coupled to the second end of the prismatic can.

18. The vehicle of claim 16, wherein the vent deflector assembly is configured to deflect high temperature gasses toward one of the first side or the second side of the vehicle body.

19. The vehicle of claim 16, wherein the vent deflector assembly is configured to deflect high temperature gasses toward one of the first end or the second end of the vehicle body.

20. The vehicle of claim 16, wherein the lid includes a first dimension and a second dimension, the first dimension being larger than the second dimension, the lid being configured to open with respect to one of the first dimension or the second dimension.
